(19) United States
(12) Patent Application Publication
(10) Pub. No.: US 2002/0198651 A1
(43) Pub. Date: Dec. 26, 2002

(54) Electronic-map searching method

(76) Inventor: Wen Hung Cheng, Taipei City (TW)

Correspondence Address: Wen Hung Cheng, PO Box 82-144, TAIPE, TW

(21) Appl. No.: 09/886,096

(22) Filed: Jun. 22, 2001

(51) Int. Cl. G01C 21/32

(52) U.S. Cl. 701/208; 340/995

(57) ABSTRACT

An electronic-map searching method is disclosed. The method comprises registering user's name; selecting to join as a member (2); inputting name, telephone number, ID numbers, PIN number, and basic data (21) of the individual user to assure identification of the user; delivering electronic maps which complied with the key-in address data by the server; proving footnotes by the system to enhance basic functions (23a) of the electronic-map transmitting modified data by the server to the website manager (24) after the enhancement of data is completed by the user; receiving the modified data by the website manager and renewing the electronic map database if the modified data has been proved correct; confirming the displayed position (23b) of the electronic-map; establishing the new data to the database (32) by the server; for registered user.

### BACKGROUND OF THE INVENTION

(a) Field of the Invention

The present invention relates to an electronic-map searching method, and in particular, a method to search electronically an electronic-map by inputting data or conditions, and at the same time, the user can also update the electronic-map data so that the data of the electronic map is complete.

(b) Description of the Prior Art

A conventional electronic-map searching method is shown in FIG. 1. On the homepage of the electronic-map website, the user can proceed with the electronic-map searching by the following methods: that is, electronically map searching based on data of location, address, road and categorized subject matters. In the conventional method, this searching by location 11 is the search by inputting the name of a destination (such as CKS Memorial Hall, Kaohsiung Train Station, etc). In some cases, the detailed address may have to be inputted. For searching based on the address search 12, the detailed address, such as, the name of the district, town, road, lane, alley, and number, have to be inputted. For searching based on road search 13, an approximate address 131 can be input without providing the detailed particulars of the address.

The above three methods require the inputting of address and then proceed with the “map search”(15). The server will deliver the electronic maps which complied with these conditions that inputted by the user.

As for categorized subject matter search 14, a wider group is provided, such as park, station, restaurants. The subject matters are classified with respect to their characteristics 14 and the server will bring out the electronic-map 16 and then transmit to the display 17 of the user.

In view of the above, there are drawbacks as follows:

(1) The procedure of input the detailed address is complicated and laborious.

(2) For searching by way of categorized subject matter, it is unable to classify or categorize classification based on characteristics for all regions.

(3) It is unclear to smaller regions, and therefore, only an approximate rough sketch of the road or street is shown.

### SUMMARY OF THE INVENTION

Accordingly, it is an object of the present invention to provide an electronic-map searching method, which mitigates the above drawbacks.

Yet another object of the present invention is to provide an electronic-map searching method, wherein the basic data established by the website user will have a corresponding electronic-map. Thus, the user is the main controller for the establishment of the data, which enlarges the scope of application of the electronic map and increases the rate of usage.

A further object of the present invention is to provide an electronic-map searching method, wherein a telephone number is input as a search condition. As one telephone number has only one corresponding address, the time of search is thus shorter.

Yet a further object of the present invention is to provide an electronic-map searching method, wherein the database of the electronic-map can provide a more complete database for searching. The website manager does not spend much time to update or manage the database.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flowchart of a conventional method of electronic-map searching.

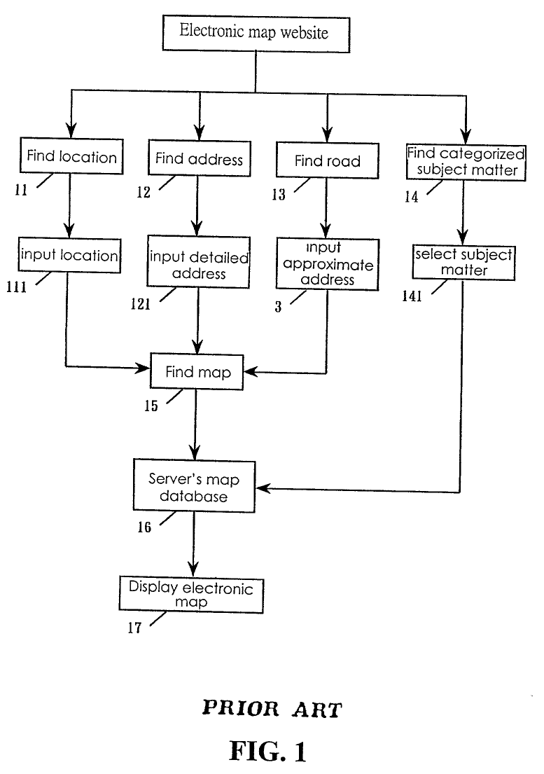

FIG. 2 is a flowchart showing the method of electronic-map search in accordance with the present invention.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

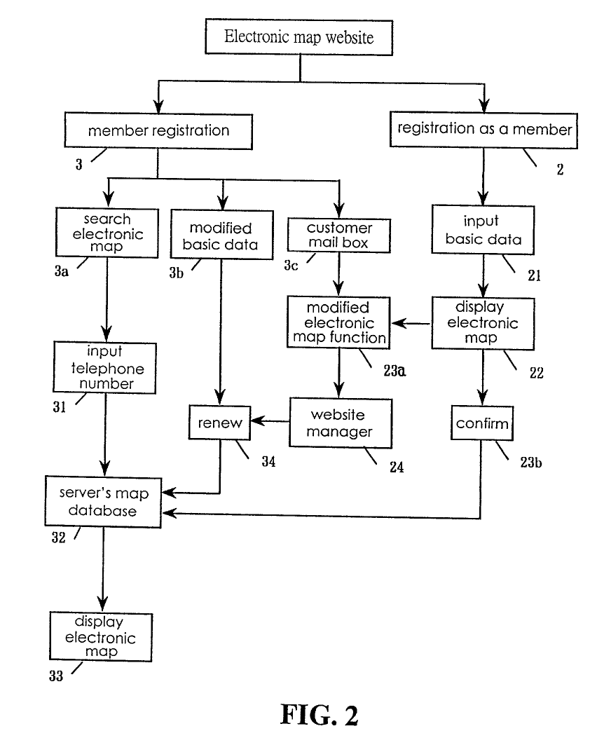

Referring to FIG. 2, there is shown a method of electronic map searching comprising the steps of registering user's name if the user is not a registered user; proceeding to join as a member (2); inputting name, telephone number, ID numbers, PIN number, and basic data (21) of the individual user to assure identification of the user; delivering electronic maps, which are complied with the input address data, by the server; if the displayed electronic-map is different from the actual map, proceeding to the following step (d); if the displayed electronic-map is similar with the actual map, proceeding to the following step (g); step (d) providing footnotes by the system to enhance basic functions (23a) of the electronic-map transmitting modified data by the server to the website manager (24) after the enhancement of data is completed by the user; receiving the modified data by the website manager and renewing the electronic map database if the modified data has been proved correct; step (g) confirming the displayed position (23b) of the electronic-map; establishing the new data to the database (32) by the server. In accordance with the present invention, if the user is a registered user, the present method comprises inputting the user's name and PIN to activate the application of the electronic map (3); providing 3 options after the member is registered, such as searching electrornic-map (3a), modifying basic data (3); and services mailbox; searching for electronic map, and proceed to delivering electronic maps which are complied with the inputted address data; searching for modification of basic data (3b), then proceeding to receiving the modified data by the website manager and renewing the electronic map database if the modified data has been proved correct; selecting service mailbox (3c), proceeding to step which confirming the displayed position 23b of the electronic-map; directly input telephone number (31) to search for electronic-map; searching for corresponding electronic map (32) based on condition by the server; after searching, transmitting the electronic-map that corresponding to the search condition to the user's display after the searching investigation is completed; renewing the original data of the server to facilitate searching after the basic data has been modified and after the renewing movement 34 of the basic data; enhancing the electronic-map by way of the enhanced electronic map function provided to the server if the map has been changed; transmitting the modified data to the website manager (24) after the user has completed the modification of data; renewing the electronic-map database after the website manager has received the corrected data and has assured the modified data being correct.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of electronic map searching by accessing to the home page of an electronic-map website to select either in establishing electronic map data or searching the electronic-map, comprising the steps of:
(I) registering user's name;
(a) selecting to join as a member (2);
(b) inputting name, telephone number, ID numbers, PIN number, and basic data (21) of the individual user to assure identification of the user;
(c) delivering electronic maps which complied with the key-in address data by the server;
(ci) if the displayed electronic-map is different from the actual map, proceeding to step (d);
(cii) if the displayed electronic-map does not have different with the actual map, proceeding to step (g);
(d) providing footnotes by the system to enhance basic functions (23a) of the electronic-map
(e) transmitting modified data by the server to the website manager (24) after the enhancement of data is completed by the user;
(f) receiving the modified data by the website manager and renewing the electronic map database if the modified data has been proved correct;
(g) confirming the displayed position (23b) of the electronic-map;
(h) establishing the new data to the database (32) by the server;
(II) for registered user,
(iia) inputting the user name and PIN to activate the application of the electronic map (3);
(iib) providing 3 options after member is registered, such as searching electronic-map (3a), modifying basic data (3); and services mailbox;
(i) searching for electronic map, proceeding to step (c);
(ii) searching for modification of basic data (3b), then proceeding to step (f);
(iii) selecting service mailbox (3c), proceeding to step (g)
(iic) directly input telephone number (31) to search for electronic-map;
(iid) searching for corresponding electronic map (32) based on condition by the server;
(iie) after searching, transmitting the electronic-map that corresponding to the search condition to the user's display after the searching investigation is completed.
(iif) renewing the original data of the server to facilitate searching after the basic data has been modified and after the renewing movement 34 of the basic data
(iig) enhancing the electronic-map by way of the enhanced electronic map function provided to the server if the map has been changed;
(iih) transmitting the modified data to the website manager (24) after the user has completed the modification of data;
(iij) renewing the electronic-map database after the website manager has received the corrected data and has assured the modified data being correct.

2. The electronic-map searching of claim 1, wherein the search condition of the electronic-map includes ID number.
